(19) United States
(12) Patent Application Publication
(10) Pub. No.: US 2013/0241312 A1
(43) Pub. Date: Sep. 19, 2013

(54) POWER SUPPLY SYSTEM

(71) Applicants: ZHI-YONG GAO, Wuhan City (CN); CHUN-LAN LIU, Wuhan City (CN); YU-LIN LIU, Wuhan City (CN)

(72) Inventors: ZHI-YONG GAO, Wuhan City (CN); CHUN-LAN LIU, Wuhan City (CN); YU-LIN LIU, Wuhan City (CN)

(21) Appl. No.: 13/632,273

(22) Filed: Oct. 1, 2012

(30) Foreign Application Priority Data
Mar. 13, 2012 (CN) 201210064265.9

(51) Int. Cl. H01H 47/00

(52) U.S. Cl. 307/113; 307/116

(57) ABSTRACT

A time-limited power supply system for providing power to an electronic device includes a first input module, a controlling module, a switch module, a display module, and an alarm module. The first input module inputs a power on time signal in the controlling module. The controlling module receives the power on time signal and outputs a power on control signal accordingly. The switch module receives the power on control signal and provides an AC voltage to the electronic device for a set time. The display module displays the time for which the power on state will continue. The controlling module outputs an alarm signal when a remaining power on time is less than a certain period of time. The alarm module issues an audible warning to remind the user that the power on time of the electronic device may need to be extended.

### BACKGROUND

1. Technical Field

The present disclosure relates to a power supply system for providing power to an electronic device for a predetermined period of time.

2. Description of Related Art

Thermal equipment is widely used in labs for testing computers. This equipment needs to be turned off by users manually after the test is complete. However, some tests last for a long time and the users can not turn off the equipments immediately after the test. The equipment would then be powered on for a long period of time and overheat, causing a hazard and a reduction in the life of the equipment.

Therefore there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a power supply system including a first input module, a second input module, a controlling module, a switch module, a decoding module, a display module, an alarm module, and a controlling apparatus.

FIG. 2 is a circuit diagram of the first input module, the controlling module, the switch module, and the alarm module of FIG. 1.

FIG. 3 is a circuit diagram of the second input module and the controlling apparatus of FIG. 1.

FIG. 4 is a circuit diagram of the decoding module and the display module of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

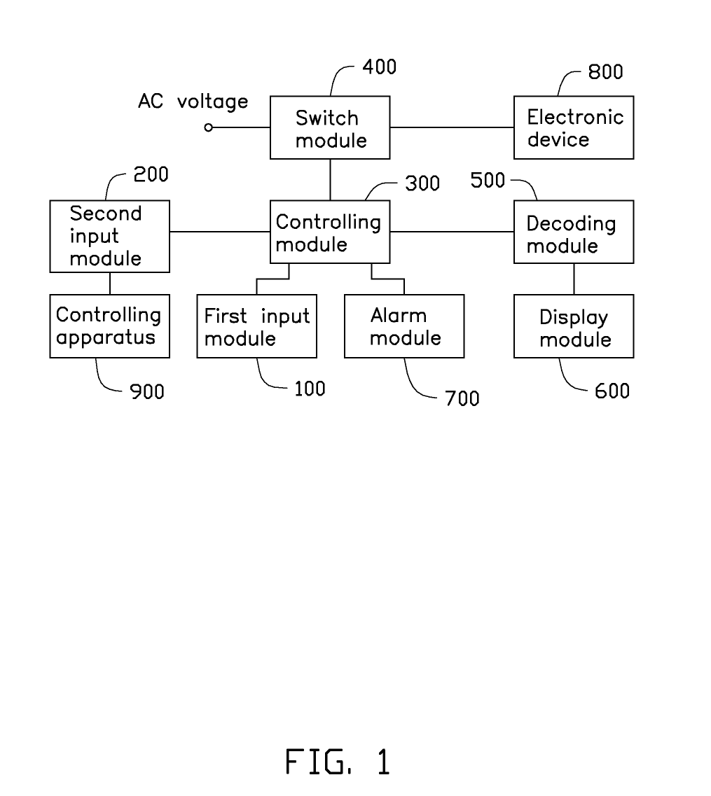

FIG. 1 illustrates a power supply system in accordance with an embodiment. The power supply system provides power to an electronic device 800. The power supply system includes a first input module 100, a second input module 200, a controlling module 300, a switch module 400, a decoding module 500, a display module 600, an alarm module 700, and a controlling apparatus 900. The first and second input modules 100 and 200 are adapted to input time signals to the controlling module 300. The controlling module 300 receives the signals, and outputs control signals to the switch module 400. The switch module 400 receives the control signals, and provides an AC voltage to the electronic device 800 accordingly. The decoding module 500 is adapted to decode the signals into digital signals which are displayed on the display module 600.

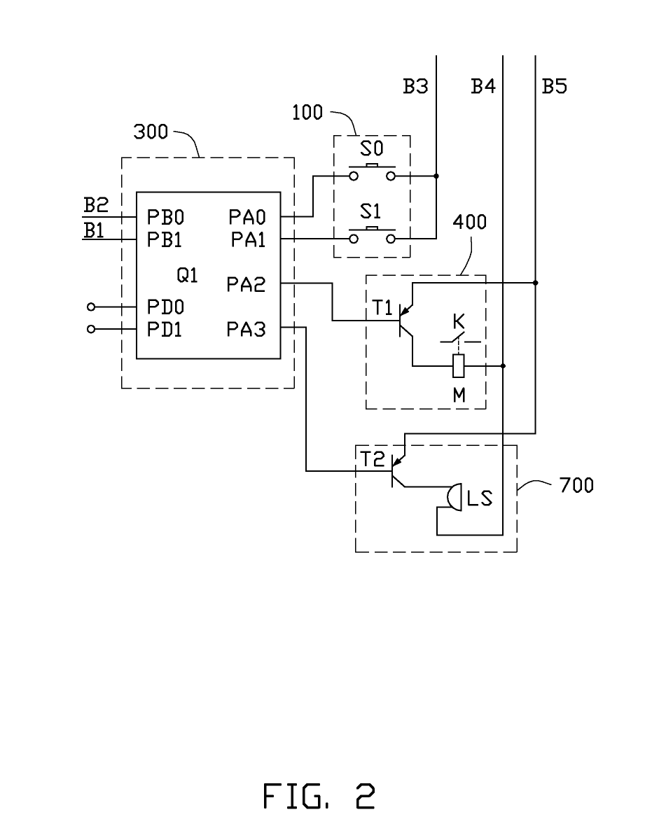

FIG. 2 illustrates the first input module 100, the controlling module 300, the switch module 100, and the alarm module 700 in accordance with one embodiment. The first input module 100 includes a first switch S0 and a second switch S1. The controlling module 300 includes a micro controller Q1. The micro controller Q1 includes a first signal input terminal PA0, a second signal input terminal PA1, a control signal output terminal PA2, an alarm signal output terminal PA3, a serial data output terminal PB0, a clock signal output terminal PB1, a digital signal receiving terminal PD0, and a digital signal transmitting terminal PD1. First terminals of the first and second switches S0 and S1 are electrically connected to the first and second signal input terminals PA0 and PA1 respectively. Second terminals of the first and second switches S0 and S1 are grounded. In one embodiment, the first and second switches S0 and S1 are pushbutton switches.

The switch module 400 includes a first transistor T1 and a relay. The relay includes a winding unit M and a switch unit K. A base of the first transistor T1 is electrically connected to the control signal output terminal PA2. An emitter of the first transistor T1 receives a DC voltage. A collector of the first transistor T1 is grounded via the winding unit M. A first terminal of the switch unit K receives the AC voltage. A second terminal of the switch unit K is electrically connected to the electronic device 800. In one embodiment, the DC voltage is about +5V.

The alarm module 700 includes a second transistor T2 and a buzzer LS. A base of the second transistor T2 is electrically connected to the alarm signal output terminal PA3. An emitter of the second transistor T2 receives the +5V DC voltage. A collector of the second transistor T2 is grounded via the buzzer LS. In one embodiment, the first and second transistors T1 and T2 are PNP type transistors.

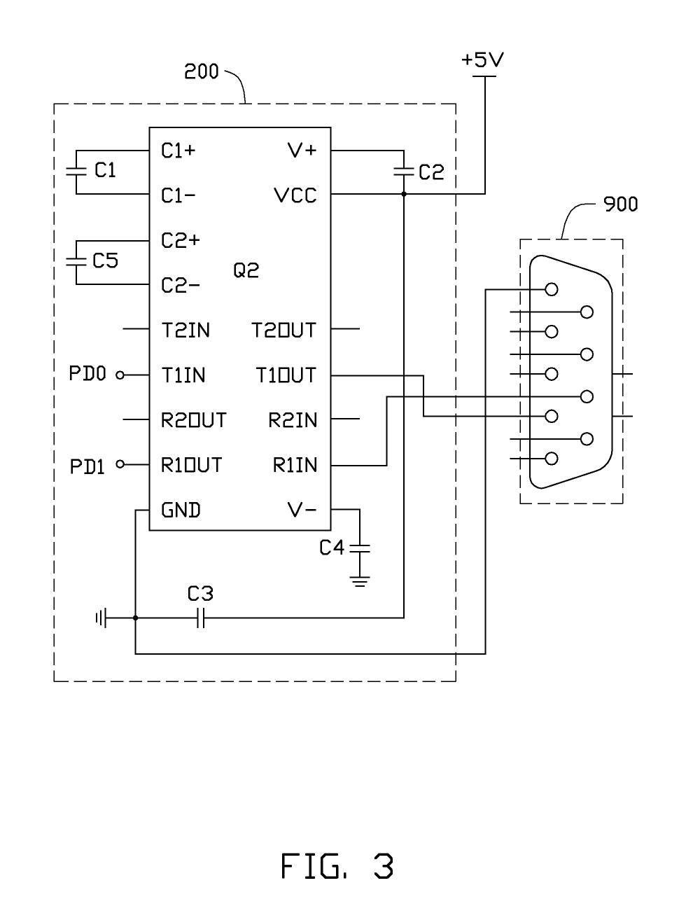

FIG. 3 illustrates the second input module 200 and the controlling apparatus 900 in accordance with one embodiment. The second input module 200 includes a voltage level conversion chip Q2 and five capacitors C1-C5. In one embodiment, the voltage level conversion chip Q2 is a MAX232 type chip for the RS-232 standard interface circuit of a computer. The voltage level conversion chip Q2 includes charge ports C1+, C1−, V+, V−, C2+, C2−, data transforming ports T1 IN, T1 OUT, R1 IN, R1 OUT, a power port VCC, and a ground port GND. The charge ports C1+, C2+ are electrically connected to the charge ports C1−, C2− via the capacitor C1 and the capacitor C5 respectively. The charge ports V+, V− are electrically connected to the +5V DC voltage and ground via the capacitor C2 and the capacitor C4 respectively. The charge ports C1+, C1−, V+, V−, C2+, C2− and the capacitors C1, C2, C4, C5 form a charge pump circuit for generating both a +12V voltage and a −12V voltage which are provided to the RS-232 standard interface circuit. The power port VCC is electrically connected to the +5V DC voltage, and grounded via the capacitor C3. The ground port GND is grounded. The data transforming port R1 IN acts as a voltage level signal receiving terminal for receiving the power on time signal from the controlling apparatus 900. The data transforming port R1 OUT acts as a voltage level signal transmitting terminal for transmitting a converted power on time signal to the digital signal receiving terminal PD0. The data transforming port T1 IN acts as a voltage level signal receiving terminal for receiving feedback signals from the digital signal transmitting terminal PD1. The data transforming port T1 OUT acts as a voltage level signal transmitting terminal for transmitting converted feedback signals to the controlling apparatus 900.

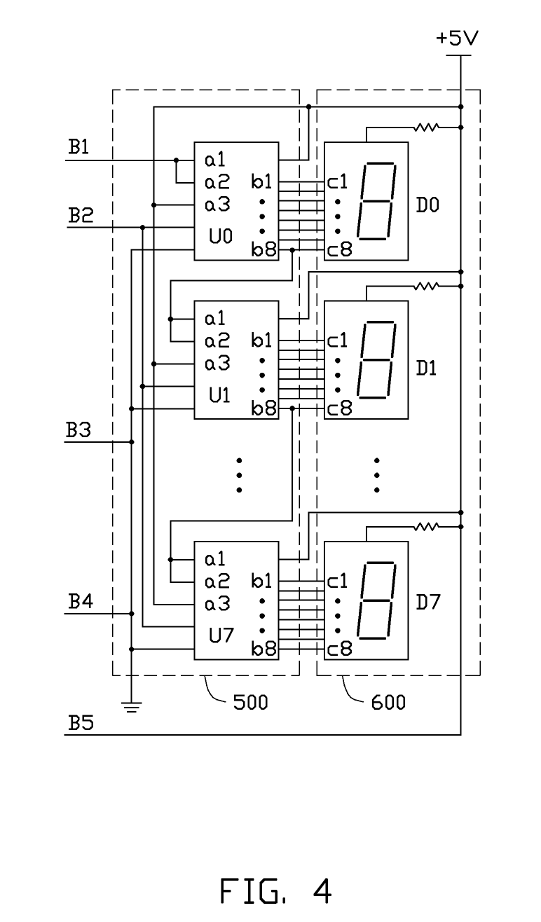

FIG. 4 illustrates the decoding module 500 and the display module 600 in accordance with one embodiment. The decoding module 500 includes a plurality of registers U0-U7. Each of the plurality of registers U0-U7 includes two serial data input terminals a1, a2, a clock signal input terminal a3 and a plurality of digital signal output terminals b1-b8. The serial data input terminals a1, a2 of the register U0 are electrically connected to the serial data output terminal PB0 of the micro controller Q1. The serial data input terminals a1, a2 of the register U1 are electrically connected to the digital signal output terminal b8 of the register U0. The serial data input terminals a1, a2 of the register U2 are electrically connected to the digital signal output terminal b8 of the register U1. The serial data input terminals a1, a2 of the register U3 are electrically connected to the digital signal output terminal b8 of the register U2. The serial data input terminals a1, a2 of the register U4 are electrically connected to the digital signal output terminal b8 of the register U3. The serial data input terminals a1, a2 of the register U5 are electrically connected to the digital signal output terminal b8 of the register U4. The serial data input terminals a1, a2 of the register U6 are electrically connected to the digital signal output terminal b8 of the register U5. The serial data input terminals a1, a2 of the register U7 are electrically connected to the digital signal output terminal b8 of the register U6. The clock signal input terminals a3 of the plurality of registers U0-U7 are electrically connected to the clock signal output terminal PB1 of the micro controller Q1.

The display module 600 includes a plurality of eight-segment numeral tubes D0-D7. Each of the plurality of eight-segment numeral tubes D0-D7 includes a plurality of digital signal input terminals c1-c8. The plurality of digital signal input terminals c1-c8 of the plurality of eight-segment numeral tubes D0-D7 correspond to, and are electrically connected to, the plurality of digital signal output terminals b1-b8 of the plurality of registers U0-U7.

In a working state, the power supply 800 is electrically connected to the system via the switch module 400. The pushbutton switch S0 is pressed to start up the system. The pushbutton switch S1 is pressed to set a time duration of the power on state. The micro controller Q1 outputs a low level power on control signal to the first transistor T1. The first transistor T1 turns on. The winding unit M is powered on to close the switch unit K. The AC voltage is thus provided to the electronic device 800. The micro controller Q1 converts the power on time signal to a digital signal which is transmitted to the register U0. The plurality of registers U0-U7 decode the digital signal to a digital value which is displayed on the plurality of eight-segment numeral tubes D0-D7. Therefore the power on time remaining is indicated during utilization of the power supply 800. When the power on time remaining is less than two minutes, the alarm signal output terminal PA3 of the micro controller Q1 outputs a low level alarm signal to the second transistor T2. The second transistor T2 turns on. The buzzer LS is thus powered on. The buzzer LS emits an audible alarm to remind the user that the power on time of the electronic device 800 may need to be extended.

In one embodiment, an extension time for each press on the pushbutton switch S1 and a point of alarm which warns when the electronic device 800 is to power off can both be manually set in the micro controller Q1. The eight-segment numeral tubes D0 and D1 display information as to hours and minutes and seconds. The eight-segment numeral tube D2 displays a decimal point between the hour information and the minute information, and between the minute information and the second information.

Even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A power supply system for providing power to an electronic device, the power supply test system comprising:
a first input module for inputting a power on time signal;
a controlling module for receiving the power on time signal and outputting a power on control signal accordingly;
a switch module for receiving the power on control signal and providing an AC voltage to the electronic device accordingly;
a display module for displaying a power on time of the electronic device; and
an alarm module, wherein the controlling module outputs an alarm signal when a remaining power on time is less than an alarming time, the alarm module receives the alarm signal and alarms to indicate whether the power on time of the electronic device needs to be extended.

2. The power supply system of claim 1, wherein the first input module comprises a first switch and a second switch; the controlling module comprises a first signal input terminal and a second signal input terminal; first terminals of the first and second switches are electrically connected to the first and second signal input terminals respectively; and second terminals of the first and second switches are grounded.

3. The power supply system of claim 2, wherein the switch comprises a first transistor and a relay; the relay includes a winding unit and a switch unit; the controlling module further comprises a control signal output terminal; a base of the first transistor is electrically connected to the control signal output terminal; an emitter of the first transistor receives a DC voltage; a collector of the first transistor is grounded via the winding unit; a first terminal of the switch unit receives the AC voltage; and a second terminal of the switch unit is electrically connected to the electronic device.

4. The power supply system of claim 3, wherein the alarm module comprises a second transistor and a buzzer; the controlling module further comprises an alarm signal output terminal; a base of the second transistor is electrically connected to the alarm signal output terminal; an emitter of the second transistor receives the DC voltage; and a collector of the second transistor is grounded via the buzzer.

5. The power supply system of claim 4, further comprising a decoding module electrically connected to the controlling module and the display module; the controlling module further comprises a serial data output terminal; the decoding module comprises at least a first register and a second register; each of the first and second registers comprises two serial data input terminals and a plurality of digital signal output terminals; the serial data input terminals of the first register are electrically connected to the serial data output terminal; and the serial data input terminals of the second register are electrically connected to one digital signal output terminal of the first register.

6. The power supply system of claim 5, wherein the display module comprises at least a first numeral tube and a second numeral tube; each of the first and second numeral tubes comprises a plurality of digital signal input terminals; the plurality of digital signal input terminals of the first numeral tube are electrically connected to the plurality of digital signal output terminals of the first register; and the plurality of digital signal input terminals of the second numeral tube are electrically connected to the plurality of digital signal output terminals of the second register.

7. The power supply system of claim 1, further comprising a second input module; the second input module comprises a first voltage level signal receiving terminal and a first voltage level signal transmitting terminal; the controlling module further comprises a digital signal receiving terminal; the first voltage level signal receiving terminal receives the power on time signal from a controlling apparatus; and the first voltage level signal transmitting terminal transmits a converted power on time signal to the digital signal receiving terminal

8. The power supply system of claim 7, wherein the second input module further comprises a second voltage level signal receiving terminal and a second voltage level signal transmitting terminal; the controlling module further comprises a digital signal transmitting terminal; the second voltage level signal receiving terminal receives feedback signals from the digital signal transmitting terminal; and the second voltage level signal transmitting terminal transmits converted feedback signals to the controlling apparatus.

9. The power supply system of claim 2, wherein the first and second switches are pushbutton switches.

10. The power supply system of claim 4, wherein the first and second transistors are PNP type transistors.

11. A power supply system for providing power to an electronic device, the power supply test system comprising:
a first input module for inputting a power on time signal;
a controlling module for receiving the power on time signal and outputting a power on control signal accordingly;
a switch module for receiving the power on control signal and providing an AC voltage to the electronic device accordingly;
a decoding module for decoding the power on time signal to a digital signal;
a display module for receiving the digital signal and displaying a power on time of the electronic device; and
an alarm module, wherein the controlling module outputs an alarm signal when a remaining power on time is less than an alarming time, the alarm module receives the alarm signal and alarms to indicate whether the power on time of the electronic device needs to be extended.

12. The power supply system of claim 11, wherein the first input module comprises a first switch and a second switch; the controlling module comprises a first signal input terminal and a second signal input terminal; first terminals of the first and second switches are electrically connected to the first and second signal input terminals respectively; and second terminals of the first and second switches are grounded.

13. The power supply system of claim 12, wherein the switch comprises a first transistor and a relay; the relay includes a winding unit and a switch unit; the controlling module further comprises a control signal output terminal; a base of the first transistor is electrically connected to the control signal output terminal; an emitter of the first transistor receives a DC voltage; a collector of the first transistor is grounded via the winding unit; a first terminal of the switch unit receives the AC voltage; and a second terminal of the switch unit is electrically connected to the electronic device.

14. The power supply system of claim 13, wherein the alarm module comprises a second transistor and a buzzer; the controlling module further comprises an alarm signal output terminal; a base of the second transistor is electrically connected to the alarm signal output terminal; an emitter of the second transistor receives the DC voltage; and a collector of the second transistor is grounded via the buzzer.

15. The power supply system of claim 14, wherein the controlling module further comprises a serial data output terminal; the decoding module comprises at least a first register and a second register; each of the first and second registers comprises two serial data input terminals and a plurality of digital signal output terminals; the serial data input terminals of the first register are electrically connected to the serial data output terminal; and the serial data input terminals of the second register are electrically connected to one digital signal output terminal of the first register.

16. The power supply system of claim 15, wherein the display module comprises at least a first numeral tube and a second numeral tube; each of the first and second numeral tubes comprises a plurality of digital signal input terminals; the plurality of digital signal input terminals of the first numeral tube are electrically connected to the plurality of digital signal output terminals of the first register; and the plurality of digital signal input terminals of the second numeral tube are electrically connected to the plurality of digital signal output terminals of the second register.

17. The power supply system of claim 11, further comprising a second input module; the second input module comprises a first voltage level signal receiving terminal and a first voltage level signal transmitting terminal; the controlling module further comprises a digital signal receiving terminal; the first voltage level signal receiving terminal receives the power on time signal from a controlling apparatus; and the first voltage level signal transmitting terminal transmits a converted power on time signal to the digital signal receiving terminal

18. The power supply system of claim 17, wherein the second input module further comprises a second voltage level signal receiving terminal and a second voltage level signal transmitting terminal; the controlling module further comprises a digital signal transmitting terminal; the second voltage level signal receiving terminal receives feedback signals from the digital signal transmitting terminal; and the second voltage level signal transmitting terminal transmits converted feedback signals to the controlling apparatus.

19. The power supply system of claim 12, wherein the first and second switches are pushbutton switches.

20. The power supply system of claim 14, wherein the first and second transistors are PNP type transistors.
